(19) United States
(12) Patent Application Publication
(10) Pub. No.: US 2013/0098977 A1
(43) Pub. Date: Apr. 25, 2013

(54) Carrier with Retention Features

(71) Applicant: Graphic Packaging International, Inc., Marietta, GA (US)

(72) Inventor: Kevin T. May, Kennesaw, GA (US)

(73) Assignee: Graphic Packaging International, Inc., Marietta, GA (US)

(21) Appl. No.: 13/655,740

(22) Filed: Oct. 19, 2012

Related U.S. Application Data
(60) Provisional application No. 61/627,861, filed on Oct. 19, 2011.

(51) Int. Cl. B65D 75/14; B31B 3/00

(52) U.S. Cl. 229/87.01; 493/52

(57) ABSTRACT

A carrier for carrying a plurality of articles. The carrier comprises a plurality of panels extending at least partially around an interior of the carrier. The plurality of panels comprises a top panel, at least one side panel foldably connected to the top panel, and at least one bottom panel foldably connected to the first side panel. The carrier further comprises at least one retention flap foldably connected to the at least one bottom panel for engaging at least one article of the plurality of articles in the carrier, the at least one retention flap is configured to prevent removal of the at least one article from the at least one open end.

### CROSS-REFERENCE TO RELATED APPLICATIONS

This application claims the benefit of U.S. Provisional Application No. 61/627,861, which was filed on Oct. 19, 2011.

### INCORPORATION BY REFERENCE

U.S. Provisional Patent Application No. 61/627,861, filed Oct. 19, 2011, is hereby incorporated by reference for all purposes as if presented herein in its entirety.

### BACKGROUND OF THE DISCLOSURE

The present disclosure generally relates to carriers or cartons for holding beverage containers or other types of articles.

### SUMMARY OF THE DISCLOSURE

In general, one aspect of the disclosure is directed to a carrier for carrying a plurality of articles. The carrier comprises a plurality of panels extending at least partially around an interior of the carrier. The plurality of panels comprises a top panel, at least one side panel foldably connected to the top panel, and at least one bottom panel foldably connected to the first side panel. The carrier further comprises at least one retention flap foldably connected to the at least one bottom panel for engaging at least one article of the plurality of articles in the carrier, the at least one retention flap is configured to prevent removal of the at least one article from the at least one open end.

In another aspect, the disclosure is generally directed to a blank for forming a carrier for carrying a plurality of articles. The blank comprises a plurality of panels and the plurality of panels comprises a top panel, at least one side panel foldably connected to the top panel, and at least one bottom panel foldably connected to the first side panel. The blank further comprises at least one retention flap foldably connected to the at least one bottom panel for engaging at least one article of the plurality of articles in the carrier. The at least one retention flap is configured to prevent removal of the at least one article from the carrier

In another aspect, the disclosure is generally directed to a method of forming a carrier for carrying a plurality of articles. The method comprises obtaining a blank comprising a plurality of panels. The plurality of panels comprises a top panel, at least one side panel foldably connected to the top panel, and at least one bottom panel foldably connected to the first side panel. The blank further comprises at least one retention flap foldably connected to the at least one bottom panel. The method further comprises forming at least a portion of an interior of the carrier by folding the panels about the plurality of articles, and positioning the retention flap to engage at least a portion of at least one article of the plurality of articles and to prevent removal of the at least one article from the carrier.

### BRIEF DESCRIPTION OF THE DRAWINGS

FIG. 1 is a plan view of a blank for forming a carrier for carrying a plurality of articles, according to a first embodiment;

FIG. 2 illustrates of a method of forming a carrier from the blank of FIG. 1;

FIG. 3 is a perspective view of the formed carrier;

FIG. 4 is a bottom perspective view of the formed carrier;

FIG. 5 is an alternate bottom perspective view of the formed carrier;

FIG. 6 is a bottom cutaway view of retention flaps of the carrier engaged with a plurality of articles;

FIG. 7 is a bottom perspective cutaway view of retention flaps of the carrier engaged with a plurality of articles;

FIG. 8 is an elevation cutaway view of retention flaps of the carrier engaged with a plurality of articles;

FIG. 9 is a plan view of a blank for forming a carrier for carrying a plurality of articles, according to a second embodiment;

FIG. 10 is a perspective view of a formed carrier;

FIGS. 11-16 illustrate a method of forming a carrier from the blank of FIG. 9;

FIG. 17 is an elevation view of retention flaps of the carrier engaged with a plurality of articles.

Corresponding parts are designated by corresponding reference numbers throughout the drawings.

### DETAILED DESCRIPTION OF THE EXEMPLARY EMBODIMENTS

The present disclosure generally relates to various features for cartons, carriers, packages, containers, etc., that contain articles such as containers, bottles, cans, boxes, etc. The articles can be used for packaging food and beverage products, for example. The articles can be made from materials suitable in composition for packaging the particular food or beverage item, and the materials include, but are not limited to, paperboard, composite paperboard and plastic, aluminum and/or other metals; glass; plastics such as PET, LDPE, LLDPE, HDPE, PP, PS, PVC, EVOH, and Nylon; and the like, or any combination thereof.

Cartons or carriers according to the present disclosure can accommodate articles of any shape. For the purpose of illustration and not for the purpose of limiting the scope of the disclosure, the following detailed description describes beverage containers (e.g., brick-shaped containers) as disposed within the carrier embodiments. In this specification, the terms “lower,” “bottom,” “upper” and “top” indicate orientations determined in relation to fully erected and upright carriers.

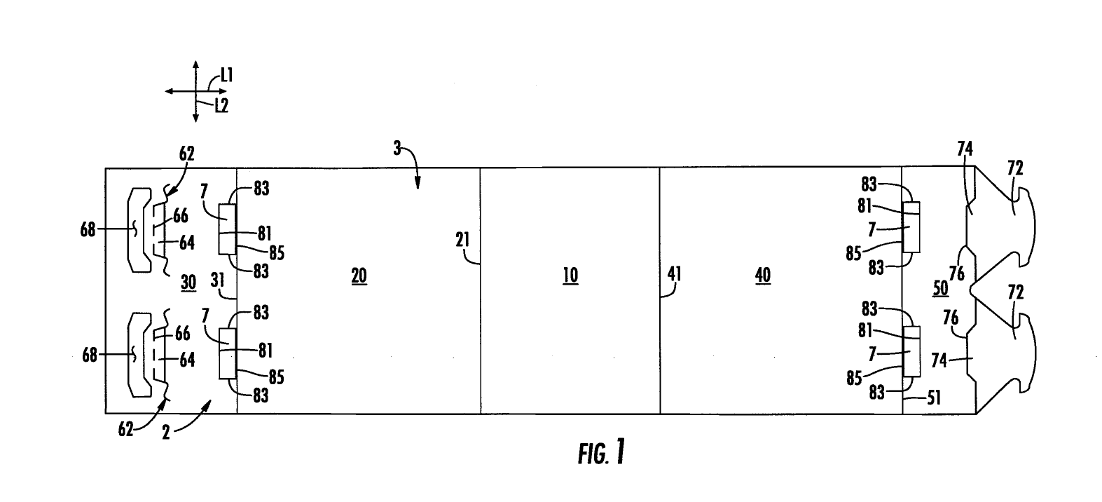

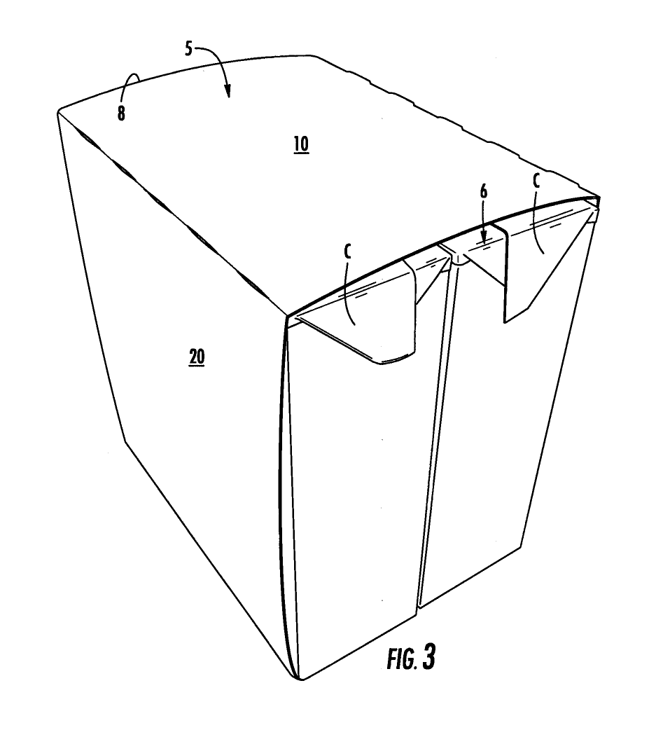

FIG. 1 is a plan view of an exterior surface 2 of a blank 3, used to form a carrier 5, shown in FIGS. 3-5, according to one embodiment of the disclosure. The carrier 5 can be used to house a plurality of articles such as containers C. In one embodiment, the containers C can be brick-shaped containers commonly referred to as TETRA PAK© containers that contain a liquid beverage or other food or beverage product. The containers C can be any suitable container such as any shape, size, and type of container that is commercially available from Tetra Pak International SA, Lausanne, Switzerland, such as TETRA BRIK packages, TETRA BRIK ASEPTIC packages, TETRA PRISM ASEPTIC packages, or any other suitable package or container. The containers C could be other suitable containers made from other materials by other manufactures (e.g., PET bottles, yogurt containers, juice-boxes, etc.) without departing form the disclosure.

In one embodiment, the blank 3 is sized to form a carrier 5 that contains four containers C or packages in a single layer in a 2×2 arrangement. But, it is understood that the blank 3 and/or carrier 5 may be sized and shaped to hold containers C of a different or same quantity in more than one layer and/or in different row/column arrangements (e.g., 1×6, 2×3, 2×6, 2×4, 2×2, 2×6×2, 2×4×2, 2×9, etc.). In the illustrated embodiment, the carrier 5 has generally open ends 6, 8 and wraps around the containers C contacting the top and bottom of the group of containers, and the carrier may be referred to as a “wrap-around carrier”.

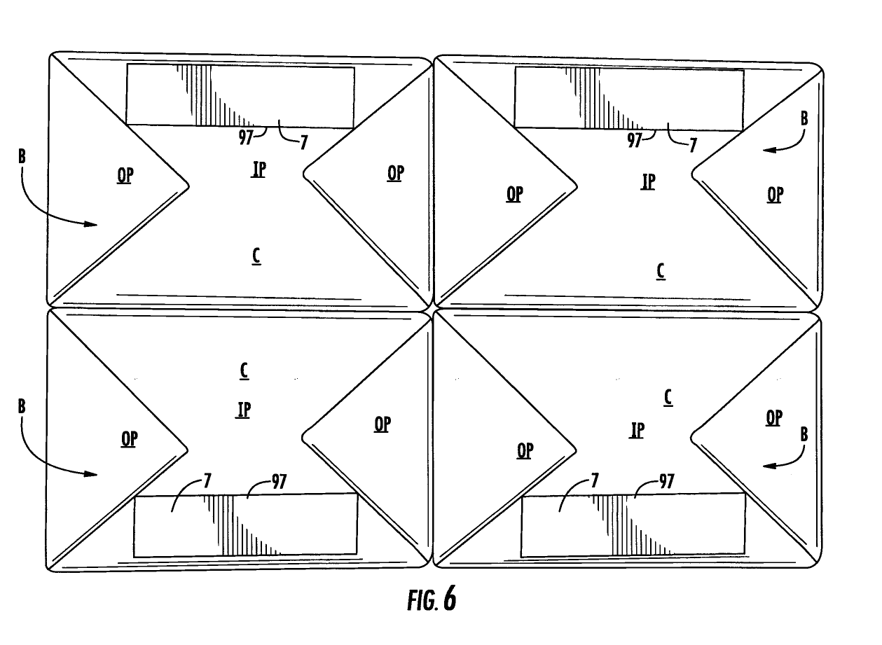

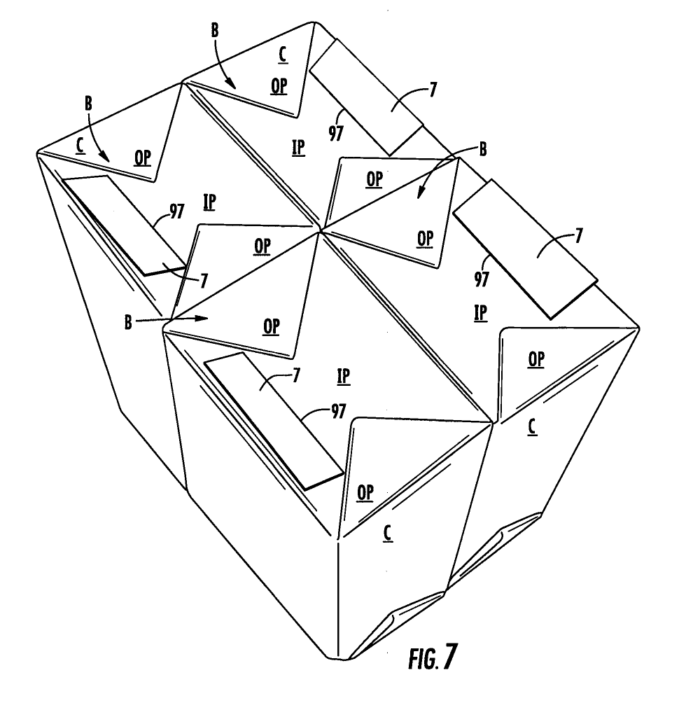

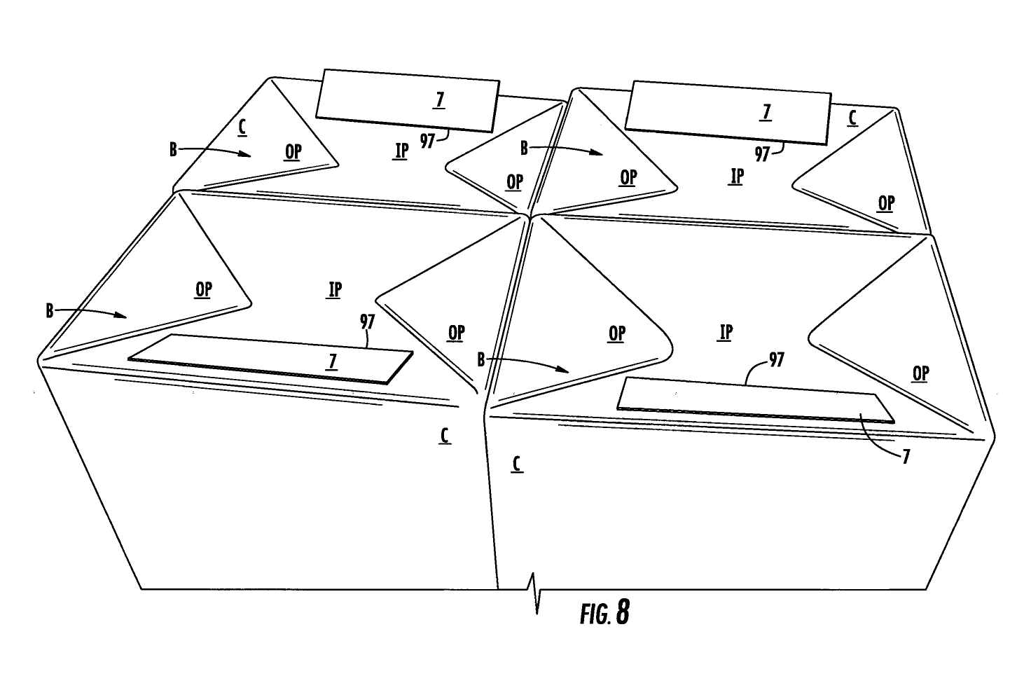

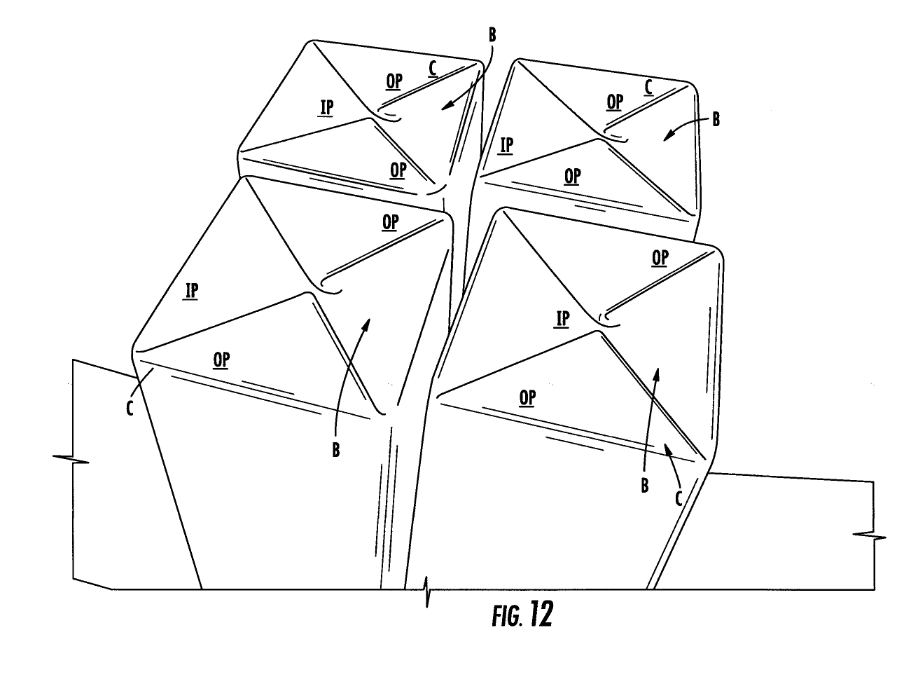

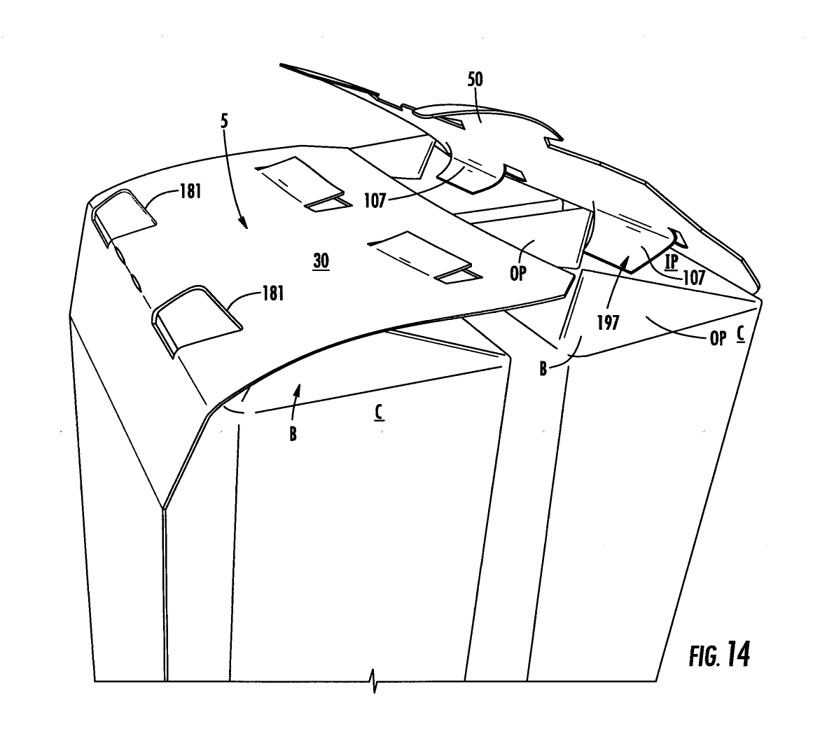

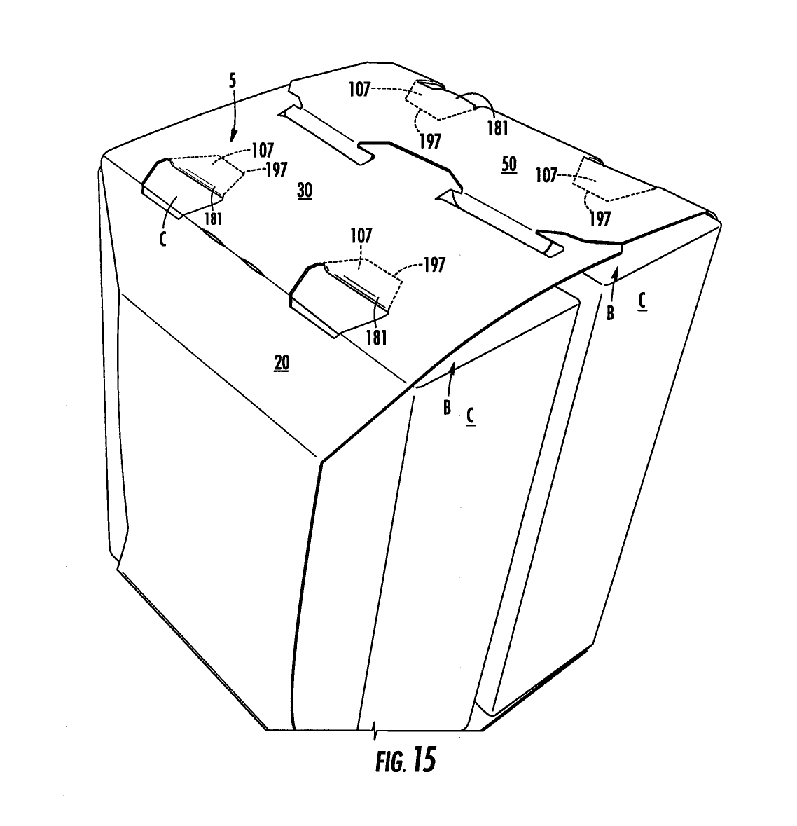

In the illustrated embodiment, the containers C are made from a composite or laminate of paperboard and plastic that is a flexible material that is folded over and sealed at the top and bottom of the container to seal the container. As shown in FIGS. 6-8 and 12-15, the containers C have a bottom B with two outer pleats OP that are folded over an inner pleat IP to form the seal at the bottom of the container. The carrier 5 of the present disclosure includes retention flaps 7 that contact the bottom B of a respective container C in a manner that engages one or more of the outer pleats OP or inner pleat IP to provide resistance to movement that prevents withdrawal of the container from the carrier. The retention flaps 7 could be configured to engage containers C having bottoms B that are otherwise shaped, arranged, and/or configured without departing from the disclosure.

As shown in FIG. 1, the blank 3 has a longitudinal axis L1 and a lateral axis L2. In the illustrated embodiment, the blank 3 comprises a top panel 10 foldably connected to a first side panel 20 at a first lateral fold line 21, a first bottom panel 30 foldably connected to the first side panel 20 at a second lateral fold line 31, a second side panel 40 foldably connected to the top panel 10 at a third lateral fold line 41, and a second bottom panel 50 foldably connected to the second side panel 40 at a fourth lateral fold line 51.

In one embodiment, the first bottom panel 30 includes cuts 62 forming a respective female locking flap 64 foldably connected to the bottom panel at a lateral fold line 66. The female locking flap is foldable to create a secondary female locking opening in the bottom panel 30. The bottom panel 30 includes primary female locking openings 68 that are adjacent the female locking flaps 64. As shown in FIG. 1, the second bottom panel 50 includes secondary male locking projections 72 at a laterally extending edge of the blank 3. In one embodiment, the second bottom panel 50 includes primary male locking projections 74 that are formed by cuts 76 in the second bottom panel. The secondary male locking projections 72 are shaped for being received in a respective secondary female locking opening corresponding to the cut 62 and the opening created by folding of the female locking flap 64. The primary male locking projections 74 are shaped for being received in a respective primary female locking opening 68. The engagement of the locking projections 72, 76 and the locking openings 62, 68 lock the first bottom panel 30 and second bottom panel in a secure engagement. The locking projections 72, 76 and locking openings 62, 68 could be otherwise shaped, arranged, configured, and/or omitted without departing from the disclosure. Further, the bottom panels 30, 50 could be engaged and attached by other means (e.g., adhesive) without departing from the disclosure.

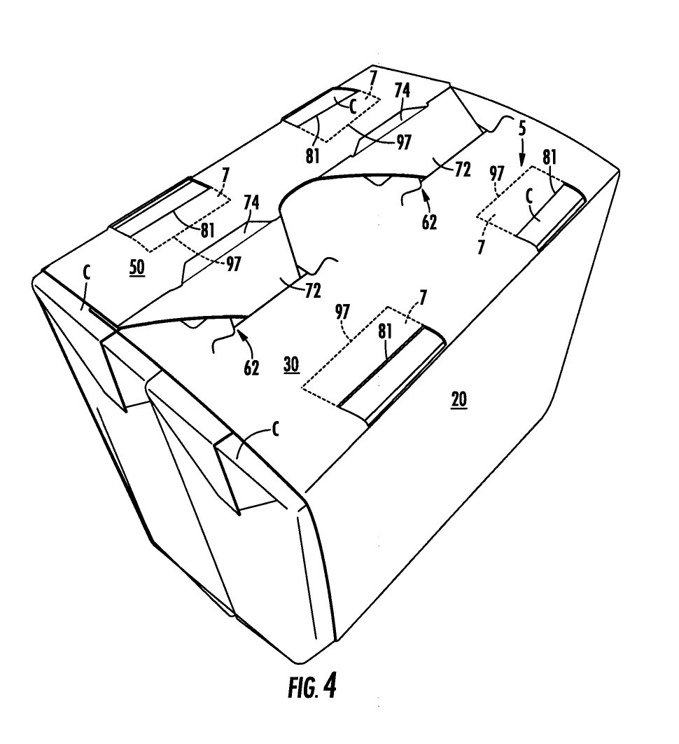

The retention flaps 7 are foldably connected to a respective one of the first bottom panel 30 and the second bottom panel 50 at a respective lateral fold line 81. In the first embodiment, the retention flaps are generally rectangular, but the retention flaps could be otherwise shaped without departing from the disclosure. The retention flaps 7 are defined by two longitudinal cuts 83 extending from respective ends of the lateral fold line 81 and a lateral cut 85 that is generally parallel to the lateral fold line 81. Cuts 83 may also include oblique cuts in some embodiments. As shown in FIG. 1, the lateral cut 85 may be slightly offset from the lateral fold line 31, 51 connecting a respective bottom panel 30, 50 to a respective side panel 20, 40, but the cuts 83, 85 that form the retention flap 7 could be otherwise shaped, arranged, and/or configured without departing from the disclosure. For example, the cuts 81, 83 could be other lines of weakening (e.g., tear lines) without departing from the disclosure. Furthermore, the lateral cut 85 may be collinear with the lateral fold line 31, 51 and separate portions of the lateral fold line 31, 51. Moreover, the lateral cut 85 may define a retention edge or free edge 97 (FIG. 4) of an associated retention flap 7.

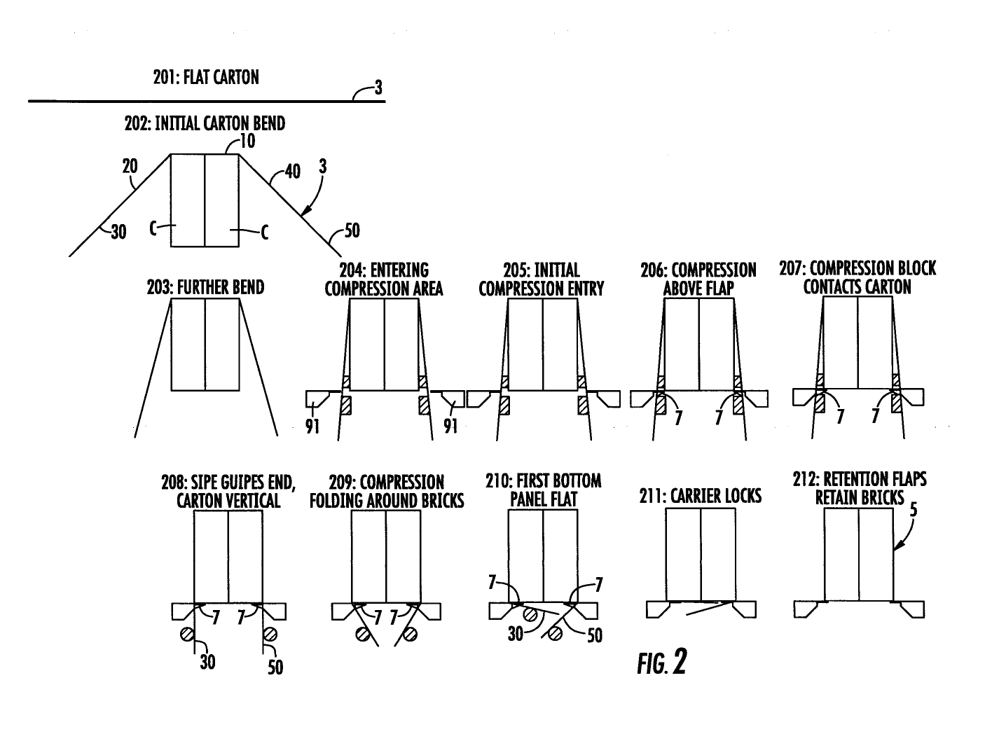

FIGS. 2-5 show various views and features of one exemplary method of forming the blank 3 into the carrier 5 using a carrier-forming machine and/or apparatus. As schematically shown in FIG. 2, the top panel 10 is placed on a group of four containers C and the side panels 20, 40 are downwardly folded in steps 201-203. The carrier-forming machine includes a compression block 91 arranged on either side of the carton 5 that engages the retention flaps and compresses the side panels 20, 40 tightly against the containers C in steps 204 and 205. As shown in Steps 206-209 of FIG. 2, the compression block 91 inwardly folds a respective retention flap 7 and further inwardly folds the side panels 20, 40 so that the retention flaps are positioned for contact with the bottoms B of the containers C when the blank 3 is tightly wrapped around the containers. As shown in Steps 209-212, the bottom panels 30, 50 are folded around the bottoms B of the containers and are locked into tight engagements. As the bottom panels 30, 50 are being brought into locking engagement, the retention flaps 7 are in face-to-face contact with a respective bottom panel and are positioned so that a free edge 97 or retention edge of the retention flap is positioned for engagement with a respective outer pleat OP on the bottoms B of the containers.

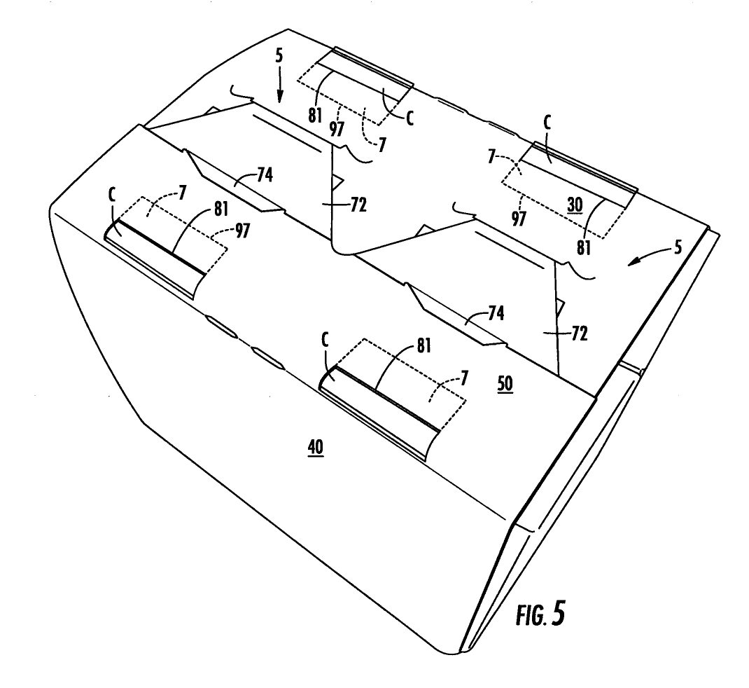

FIG. 3 shows a perspective of an assembled carrier 5 containing four containers. FIGS. 4 and 5 show a bottom view of the carrier 5 showing the retention flaps 7 in phantom in the inwardly folded position for engagement with the pleats OP, IP of the containers C. As shown, the retention flaps are substantially rectangular flaps dimensioned to engage at least a minor surface (e.g., inner pleats IP) of the containers C.

FIGS. 6-8 illustrate an initial retaining position of the retention flaps 7 with the remaining portions of the carton or carrier 5 removed to show the positioning of the retention flaps on the containers. The retention flaps 7 can be positioned to contact the two outer pleats OP of a respective container, or the retention flaps 7 can be positioned adjacent to the two respective outer pleats OP to prevent movement of the containers C, to prevent the containers C from falling out of open ends of the carrier 5, and/or to prevent removal of the containers C from open ends of the carrier 5. The retention flaps 7 can be otherwise shaped, arranged, configured, and/or positioned without departing from the disclosure. As also illustrated, the width of the retention flaps 7 may be less than the width of a minor surface (e.g., inner pleats IP) of the containers C.

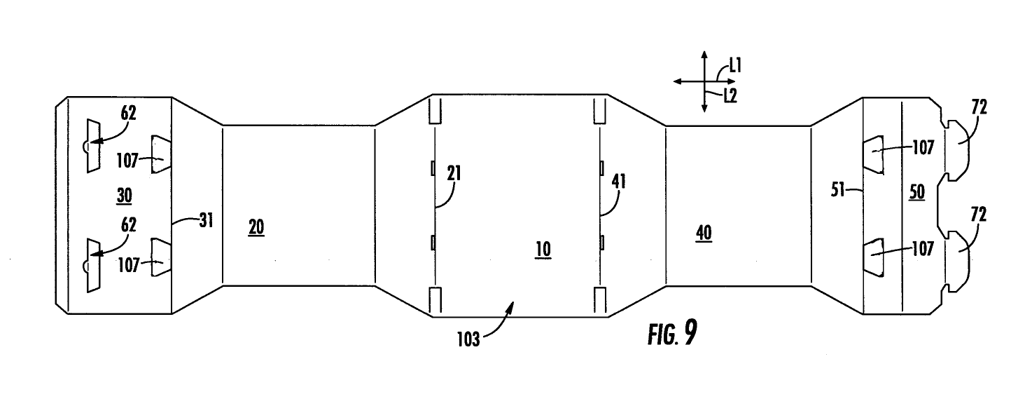

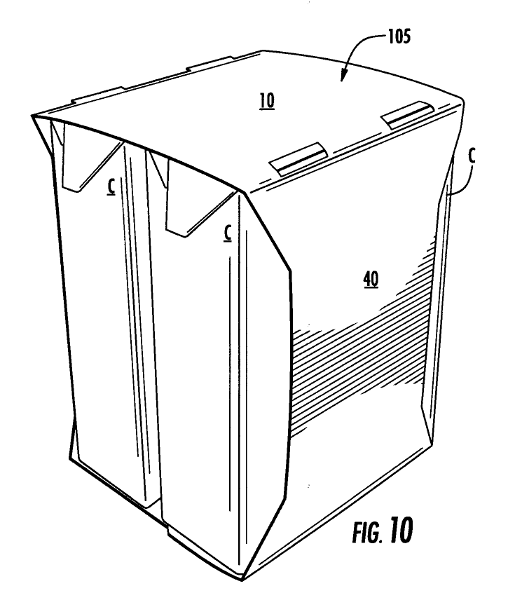

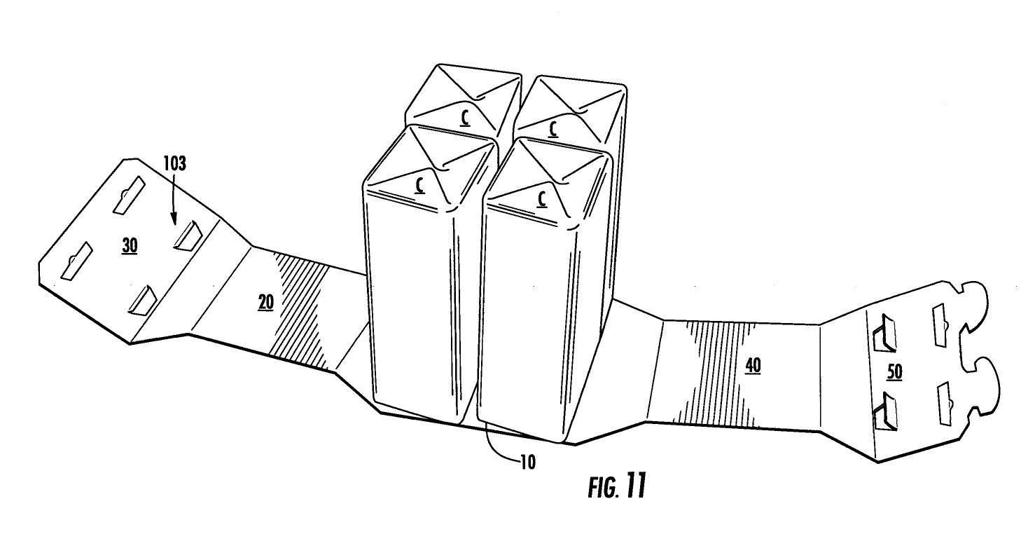

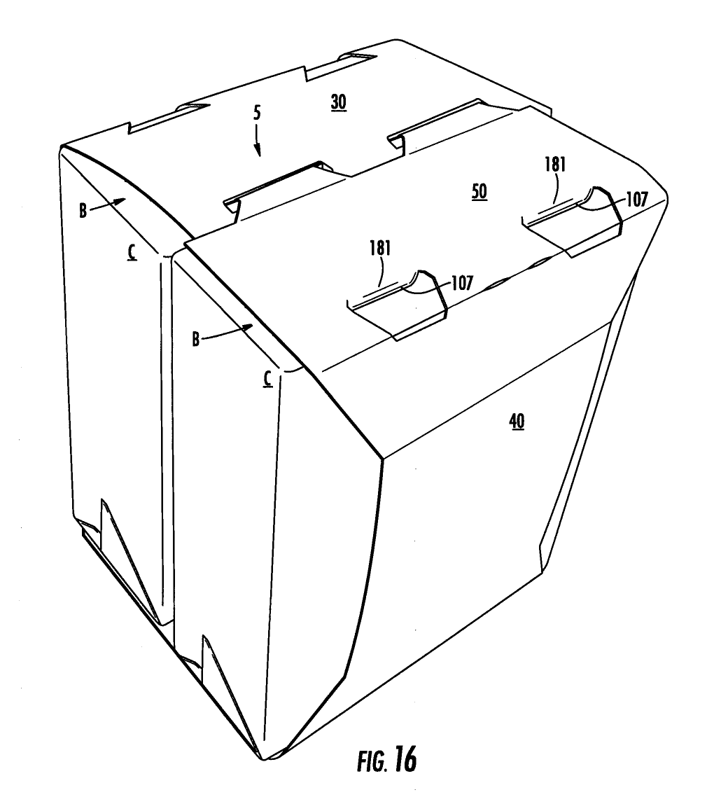

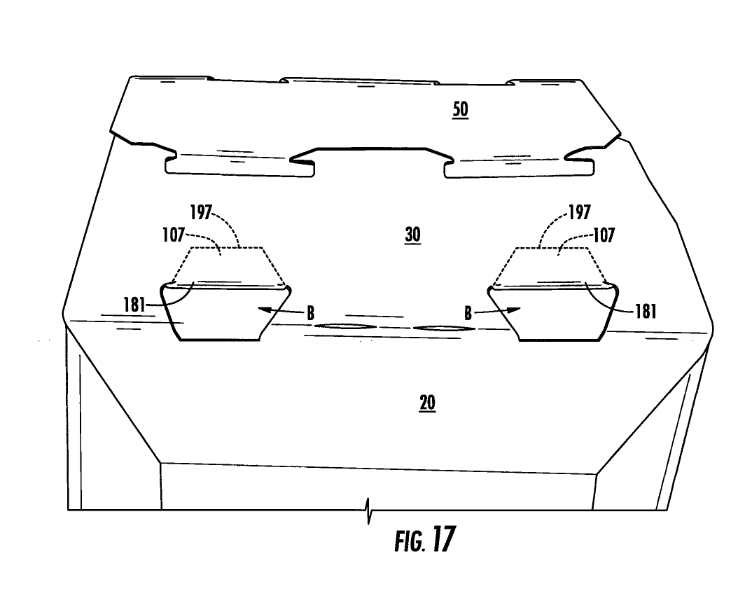

FIGS. 9-17 illustrate a blank 103 and associated carrier 105 of a second embodiment of the disclosure having similar features as the first embodiment. Accordingly, similar or identical features of the embodiments are provided with identical or similar reference numbers. The blank 103 is for forming a carton or carrier 105 (FIG. 10). The blank 103 includes male locking projections 72 that are foldably connected to the second bottom panel 50 and female locking openings 62 similar to the male and female locking openings of the first embodiment. In the second embodiment, the blank has retention flaps 107 that are similar to the retention flaps 7 of the first embodiment. The retention flaps 107 are generally trapezoidal in shape and in one embodiment can be in the shape of an isosceles trapezoid. The retention flaps 107 may also be substantially rectangular in shape with tapered edges. The tapered edges of the retention flaps 107 may also be dimensioned to engage associated pleats of the illustrated containers C. The retention flaps 107 could be otherwise shaped, arranged, and configured without departing from the disclosure.

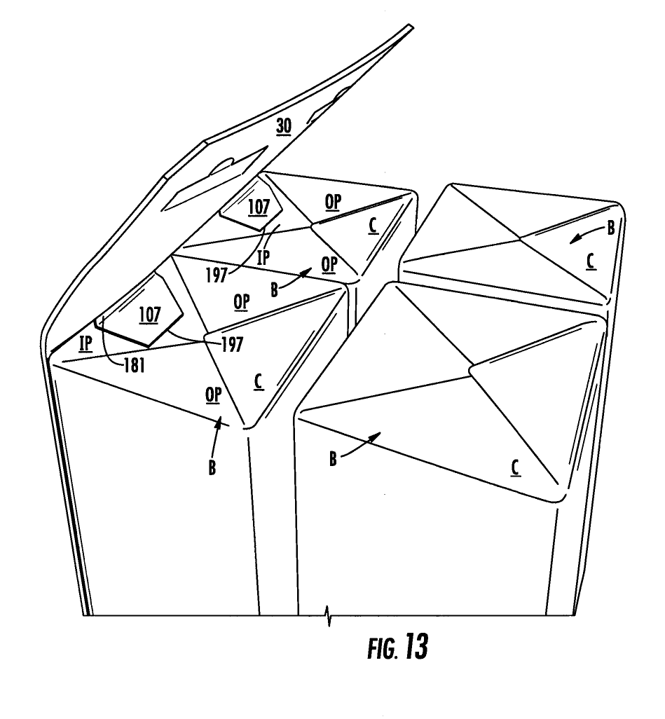

The carrier 105 is formed in a similar manner as the carrier 5 of the previous embodiment. FIGS. 10-17 illustrate forming the blank 103 into the carrier 105 by wrapping the blank 103 around the group of four containers C in a similar manner as described above for the first embodiment (e.g., FIG. 2). As shown in FIGS. 13-15, the retention flaps 107 are folded about fold lines 181 so that the free edges 197 of the retention flaps are positioned to engage protrusions on the bottom surface B of the containers C that can be the outer pleats OP that are generally triangular shaped, the inner pleats IP, or any other protrusion or surface suitable for engagement with the retention flaps 107. The engagement of the retention flaps 107 with the bottom surfaces B of the containers C retains the containers in the carrier 105. Further, the retention flaps 107 can be spaced apart or adjacent a bottom surface of the containers (e.g., outer pleats OP, inner pleats IP, or any other surface) to act as a bumper that prevents or limits movement of the containers C relative to the carrier 105. The eliminated or reduced movement of the containers C in the carrier 105 prevents the containers from falling out of the open ends of the carrier 105 and/or prevents their removal from the open ends of the carrier 105.

In general, the blank may be constructed from paperboard having a caliper so that it is heavier and more rigid than ordinary paper. The blank can also be constructed of other materials, such as cardboard, or any other material having properties suitable for enabling the carrier to function at least generally as described above. The blank can be coated with, for example, a clay coating. The clay coating may then be printed over with product, advertising, and other information or images. The blanks may then be coated with a varnish to protect information printed on the blanks. The blanks may also be coated with, for example, a moisture barrier layer, on either or both sides of the blanks. The blanks can also be laminated to or coated with one or more sheet-like materials at selected panels or panel sections.

As an example, a tear line can include: a slit that extends partially into the material along the desired line of weakness, and/or a series of spaced apart slits that extend partially into and/or completely through the material along the desired line of weakness, or various combinations of these features. As a more specific example, one type tear line is in the form of a series of spaced apart slits that extend completely through the material, with adjacent slits being spaced apart slightly so that a nick (e.g., a small somewhat bridging-like piece of the material) is defined between the adjacent slits for typically temporarily connecting the material across the tear line. The nicks are broken during tearing along the tear line. The nicks typically are a relatively small percentage of the tear line, and alternatively the nicks can be omitted from or torn in a tear line such that the tear line is a continuous cut line. That is, it is within the scope of the present disclosure for each of the tear lines to be replaced with a continuous slit, or the like. For example, a cut line can be a continuous slit or could be wider than a slit without departing from the present disclosure.

In accordance with the exemplary embodiments, a fold line can be any substantially linear, although not necessarily straight, form of weakening that facilitates folding therealong. More specifically, but not for the purpose of narrowing the scope of the present disclosure, fold lines include: a score line, such as lines formed with a blunt scoring knife, or the like, which creates a crushed or depressed portion in the material along the desired line of weakness; a cut that extends partially into a material along the desired line of weakness, and/or a series of cuts that extend partially into and/or completely through the material along the desired line of weakness; and various combinations of these features. In situations where cutting is used to create a fold line, typically the cutting will not be overly extensive in a manner that might cause a reasonable user to incorrectly consider the fold line to be a tear line.

The above embodiments may be described as having one or more panels adhered together by glue during erection of the carrier embodiments. The term “glue” is intended to encompass all manner of adhesives commonly used to secure carrier panels in place.

The foregoing description of the disclosure illustrates and describes various embodiments. As various changes could be made in the above construction without departing from the scope of the disclosure, it is intended that all matter contained in the above description or shown in the accompanying drawings shall be interpreted as illustrative and not in a limiting sense. Furthermore, the scope of the present disclosure covers various modifications, combinations, alterations, etc., of the above-described embodiments. Additionally, the disclosure shows and describes only selected embodiments, but various other combinations, modifications, and environments are within the scope of the disclosure as expressed herein, commensurate with the above teachings, and/or within the skill or knowledge of the relevant art. Furthermore, certain features and characteristics of each embodiment may be selectively interchanged and applied to other illustrated and non-illustrated embodiments of the disclosure.

What is claimed is:

1. A carrier for carrying a plurality of articles, the carrier having at least one open end, the carrier comprising:
a plurality of panels extending at least partially around an interior of the carrier, the plurality of panels comprises a top panel, at least one side panel foldably connected to the top panel, and at least one bottom panel foldably connected to the first side panel; and
at least one retention flap foldably connected to the at least one bottom panel for engaging at least one article of the plurality of articles in the carrier, the at least one retention flap being configured to prevent removal of the at least one article from the at least one open end.

2. The carrier of claim 1, wherein the at least one retention flap is foldably connected to the first bottom panel at a first fold line, and the at least one side panel is foldably connected to the at least one bottom panel at a second fold line, the first fold line being spaced apart from the second fold line.

3. The carrier of claim 2, wherein the first fold line is a lateral fold line extending across the at least one retention flap, and the at least one retention flap is at least partially defined by a cut.

4. The carrier of claim 3, wherein the cut extends between and separates portions of the second fold line.

5. The carrier of claim 3, wherein the at least one retention flap has a retention edge spaced apart from a surface of the at least one article.

6. The carrier of claim 5, wherein the at least one retention flap is a substantially rectangular flap.

7. The carrier of claim 6, wherein the surface of the at least one article comprises at least one pleat.

8. The carrier of claim 7, wherein the substantially rectangular flap comprises tapered edges.

9. The carrier of claim 8, wherein the tapered edges are dimensioned to engaged the at least one pleat.

10. The carrier of claim 5, wherein the cut comprises at least three cuts in the at least one bottom panel.

11. The carrier of claim 10, wherein the at least three cuts comprise two longitudinal cuts and a lateral cut, the lateral cut at least partially defining the retention edge of the at least one retention flap.

12. The carrier of claim 11, wherein the width of the at least one retention flap is less than a width of a minor surface of the at least one article.

13. The carrier of claim 12, wherein the minor surface of the at least one article is an inner pleat.

14. The carrier of claim 10, wherein the at least three cuts comprise two oblique cuts and a lateral cut extending across a portion of a width of the at least one retention flap.

15. The carrier of claim 1, wherein the at least one side panel is a first side panel and the at least one bottom panel is a first bottom panel, the plurality of panels further comprising:
a second side panel foldably connected to the top panel and a second bottom panel foldably connected to the second side panel.

16. The carrier of 15, wherein the at least one retention flap comprises a first retention flap, the at least one article is a first article, and the carrier further comprises:
a second retention flap foldably connected to the second bottom panel for engaging a second article of the plurality of articles and to prevent removal of the second article from the at least one open end.

17. A blank for forming a carrier for carrying a plurality of articles, the blank comprising:
a plurality of panels, the plurality of panels comprises a top panel, at least one side panel foldably connected to the top panel, and at least one bottom panel foldably connected to the first side panel; and
at least one retention flap foldably connected to the at least one bottom panel for engaging at least one article of the plurality of articles in the carrier, the at least one retention flap being configured to prevent removal of the at least one article from the carrier.

18. The blank of claim 17, wherein the at least one retention flap is foldably connected to the first bottom panel at a first fold line, and the at least one side panel is foldably connected to the at least one bottom panel at a second fold line, the first fold line being spaced apart from the second fold line.

19. The blank of claim 18, wherein the first fold line is a lateral fold line extending across the at least one retention flap, and the at least one retention flap is at least partially defined by a cut.

20. The blank of claim 19, wherein the cut extends between and separates portions of the second fold line.

21. The blank of claim 19, wherein the at least one retention flap is a substantially rectangular flap.

22. The blank of claim 21, wherein the substantially rectangular flap comprises tapered edges.

23. The blank of claim 22, wherein the tapered edges are dimensioned to engaged a surface of the at least one article.

24. The blank of claim 19, wherein the cut comprises at least three cuts in the at least one bottom panel.

25. The blank of claim 24, wherein the at least three cuts comprise two longitudinal cuts and a lateral cut, the lateral cut at least partially defining a retention edge of the at least one retention flap.

26. The blank of claim 25, wherein the width of the at least one retention flap is less than a width of a minor surface of the at least one article.

27. The blank of claim 24, wherein the at least three cuts comprise two oblique cuts and a lateral cut extending across a portion of a width of the at least one retention flap.

28. The blank of claim 17, wherein the at least one side panel is a first side panel and the at least one bottom panel is a first bottom panel, the plurality of panels further comprising:
a second side panel foldably connected to the top panel and a second bottom panel foldably connected to the second side panel.

29. The blank of 28, wherein the at least one retention flap comprises a first retention flap, the at least one article is a first article, and the blank further comprises:
a second retention flap foldably connected to the second bottom panel for engaging a second article of the plurality of articles and to prevent removal of the second article from the carrier.

30. A method of forming a carrier for carrying a plurality of articles, the method comprising:
obtaining a blank comprising a plurality of panels, the plurality of panels comprises a top panel, at least one side panel foldably connected to the top panel, and at least one bottom panel foldably connected to the first side panel, and the blank further comprising at least one retention flap foldably connected to the at least one bottom panel, the at least one retention flap being configured to prevent removal of the at least one article from the carrier;
forming at least a portion of an interior of the carrier by folding the panels about the plurality of articles; and
positioning the retention flap to engage at least a portion of at least one article of the plurality of articles and to prevent removal of the at least one article from the carrier.

31. The method of claim 30, wherein forming at least the portion of the interior of the carrier includes forming a sleeve having at least one open end, and wherein the at least one retention flap is further configured to prevent removal of the at least one article from the at least one open end.

32. The method of claim 30, wherein positioning the retention flap comprises positioning a compression block to engage the at least one retention flap.

33. The method of claim 32, wherein forming at least the portion of the interior of the carrier includes compressing the at least one side panel against the at least one article.

34. The method of claim 30, wherein the at least one side panel is a first side panel and the at least one bottom panel is a first bottom panel, the plurality of panels further comprising:
a second side panel foldably connected to the top panel and a second bottom panel foldably connected to the second side panel.

35. The method of claim 34, wherein the at least one retention flap comprises a first retention flap, the at least one article is a first article, and the blank further comprises:
a second retention flap foldably connected to the second bottom panel for engaging a second article of the plurality of articles and to prevent removal of the second article from the carrier.

36. The method of claim 35, wherein positioning the retention flap comprises positioning compression blocks to engage the first and second retention flaps.

37. The method of claim 36, wherein forming at least the portion of the interior of the carrier includes compressing the first side panel against the first article and compressing the second side panel against the second article.
